(19) United States
(12) Patent Application Publication
(10) Pub. No.: US 2009/0095233 A1
(43) Pub. Date: Apr. 16, 2009

(54) Dog collar

(76) Inventor: Daniel Trujillo, Sacramento, CA (US)

Correspondence Address: MATHEW J. TEMMERMAN, 423 E. STREET, DAVIS, CA, 95616, US

(21) Appl. No.: 11/974,624

(22) Filed: Oct. 15, 2007

(51) Int. Cl. A01K 13/00

(52) U.S. Cl. 119/855

(57) ABSTRACT

An improved dog collar manufactured from a two-component collar sewn together and further comprising an internal area. The internal area is substantially filled with a flat curved metallic bar. To protect the inside of the outer component off the collar from abrasions caused by friction against the edges of the metallic insert, the ends of the metallic insert are curved, and a second patch of material is positioned against the curved metal end. In use, a dog will wear the collar as if it is a conventional collar, but will have its neck area protected from potential attack from other dogs.

### FIELD OF THE INVENTION

The present invention relates to dog collars, and particularly to protective dog collars.

### GENERAL BACKGROUND AND OBJECTIVES OF THE INVENTION

The present invention relates to dog collars, and more particularly to protective dog collars. Dog collars are used by owners to secure, lead, and control their animals. Because so many dogs have become accustomed to wearing such collars, improvements to them generally provide a benefit for the animal with little detriment.

The ancestors of all domestic breeds of dogs were wolves. Considering this history, and the fact that dogs are social animals, it is not uncommon for dogs to assert their dominance over one another through fighting. In addition, historically certain breeds of dogs were bred with the tendency to fight. Due to all of these factors, it is not uncommon for sporadic and unprompted fights to break out between dogs. It is well known that as a natural instinct, dogs will tend to bite for the neck of their target during an attack. Because the neck is one of the most vulnerable areas, an attack can leave one dog critically injured, bringing great expense and emotional turmoil to both the animal and its owner.

It is thus an objective of the present invention to provide an improved dog collar that protects the neck of the dog wearing the dog collar.

It is a second objective of the present invention to provide a wide protective strip around a dog's neck.

It is a third objective of the present invention to provide a durable, cost-efficient collar that is easily assembled.

It is a fourth objective of the present invention to provide a collar comprising means for reducing wear from friction caused by an metal insert within the collar, and means for reducing potential injury to the animal from the device.

Additional objects and advantages of the present invention will become obvious to the reader and it is intended that these objects and advantages be within the scope of the present invention.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 is am environmental view of the applicant's improved dog collar worn by a dog.

FIG. 2 is a cut-away plan view of applicant's improved dog collar according to a preferred embodiment of the invention.

FIG. 3 is a plan view with phantom lines depicting the internal structure of the applicant's improved dog collar according to a preferred embodiment of the invention. Cross sectional lines are shown, corresponding to figure numbers associated therewith.

FIG. 4 is a cross sectional view taken along cut line 4-4 in FIG. 3 depicting the improved dog collar according to the preferred embodiment of the invention.

FIG. 5 is a cross sectional view taken along cut line 5-5 in FIG. 3 depicting the improved dog collar according to the preferred embodiment of the invention.

### SUMMARY OF THE INVENTION

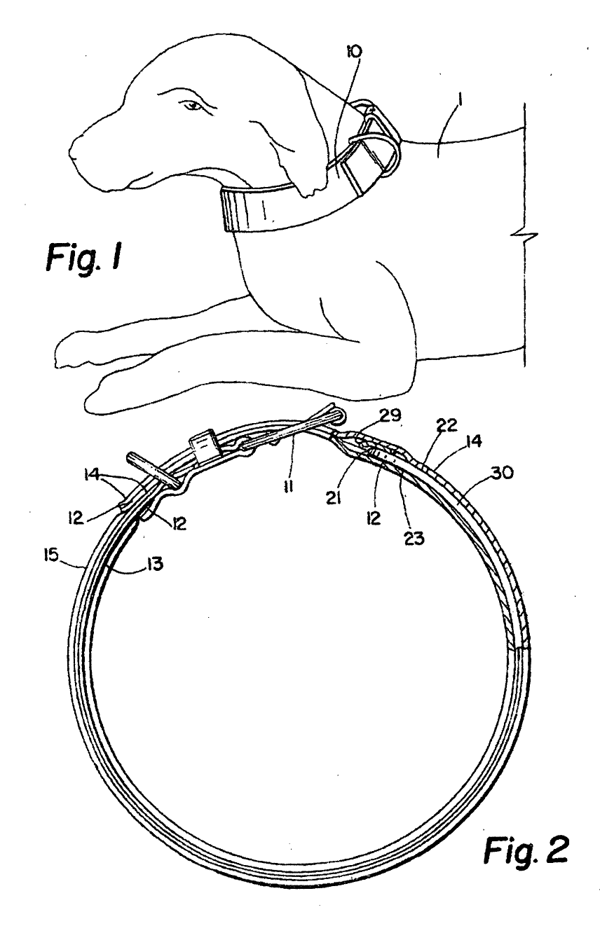

The present invention is an improved dog collar (see FIG. 1) manufactured from an inner layer and outer layer sewn together and further comprising an internal area. The internal area is substantially filled with a curved metallic bar. To protect the inside of the outer layer from abrasions caused by friction against the edges of the metallic insert, the ends of the metallic insert are curved, and a second patch of material is positioned against the curved metal end.

In use, the dog or other animal will wear the collar as if it is a conventional collar, but will have its neck area protected from potential attack from other dogs.

### DETAILED DESCRIPTION OF THE INVENTION

The present invention is an improved dog collar (see FIG. 1) manufactured from an inner layer and outer layer affixed together and further comprising an internal area. The internal area is substantially filled with a curved metallic bar. To protect the inside of the outer layer from abrasions caused by friction against the edges of the metallic insert, the ends of the metallic insert are curved, and a second patch of material is positioned against the curved metal end. In alternative embodiments of the invention, not shown, the collar may be worn by other domesticated animals and livestock that may be susceptible to an attack at the neck.

Referring first to FIG. 1, an environmental view of a dog 1 wearing the disclosed collar 10 is depicted. A plan view of the collar is depicted in FIG. 2, with one portion cut away to reveal the components inside the collar.

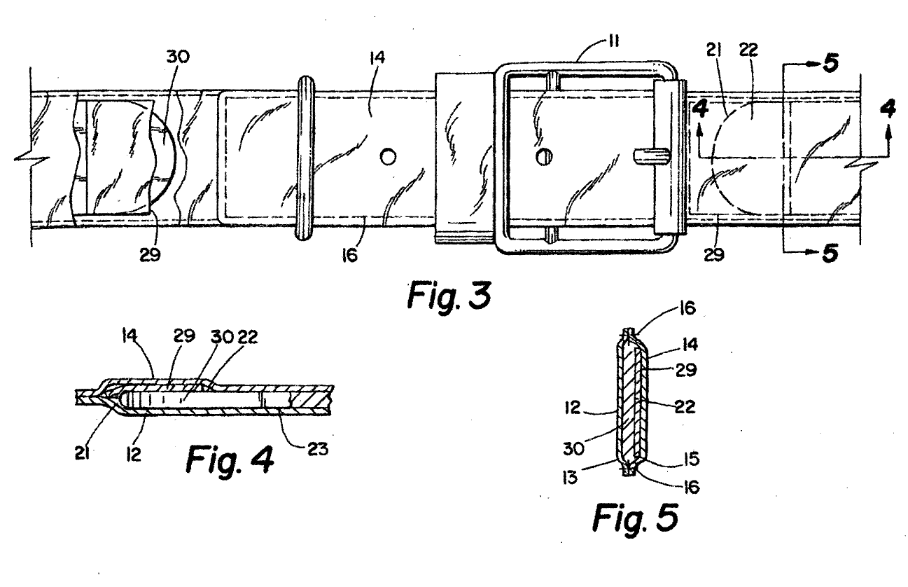

The collar 10 comprises two layers of material, affixed together. The material is preferably nylon, but may also be leather, or other flexible and strong materials typically composing a dog collar. The outer layer 14 and inner layer 12 are in a preferred embodiment sewn together. Turning briefly to FIG. 3, a sewing line 15 is depicted where the outer layer 14 (shown) and inner layer (12) are affixed together. Other means of affixing the layers together may be employed, including but not limited to gluing, fusing, riveting, and sonic welding.

Referring now to FIGS. 2 and 5, the raised edges of the inner layer 12 and the outer layer 14 is shown as inner layer raised edge 13 and outer layer raised edge 14. The edge is raised due to the presence of metallic insert 30 pushing the inner layer 12 and outer layer 14 away from one another.

Metallic insert 30 may be made of strong flexible material non-resulting materials such as high-grade lightweight aluminum or an aluminum alloy. A material resistant to corrosive degradation is desired. Metallic insert 30 has two sides, as shown in FIG. 2, metallic insert inner side 23 and metallic insert outer side 22. To keep the applicant's device cost efficient, the metallic insert 30 is preferably created through bending a long straight metallic bar. During compression of the collar and merely from movement of the animal wearing the collar, the metallic insert outer side 22 tends to push against inner layer 12, particularly at its ends. Thus, three mechanisms are employed to prevent wear on inner layer 12. First, metallic insert 30 has a curved end, shown again in FIGS. 3 and 4. This curved end eliminates sharp edges that may concentrate wear on a small surface of inner layer 12. Second, the metallic bar has no sharp edges. Thus, every edge has been filed or grinded so as to create a curved surface as shown best in FIG. 5, but also visible in FIGS. 4 and 2. Third, a protective insert 29 is placed on each end of the metallic insert 30 at the point where said metallic insert 30 pushes against inner layer 12. The protective insert 29 is depicted in FIGS. 2-5.

Protective insert 29 can be made from the same material as the inner layer 12 and outer layer 14, or can be made from other stronger materials such as leather or plastic. In an alternative embodiment, the protective insert 29 is an extension of said outer layer 14 in that outer layer 14 is thicker at the point where protective insert 29 is shown. The alternative embodiment is not depicted in the figures.

A conventional buckle 11, as shown in FIGS. 2 and 3, allows the collar 10 to operate as would a conventional collar. Other means of securing collars can be utilized, as are known in the art.

In use, dog 1 wears collar 10 as it would a conventional collar. However, the improved and strengthened collar

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

1. An improved animal collar for protecting the neck of an animal, the improved animal collar comprising:
a. a first material and a second material affixed together;
b. a curved noncorrosive metallic insert nested between said first and second materials, said metallic insert comprising at least one curved end and having no sharp edges; and
c. a latching mechanism for securing said improved animal collar about said neck of an animal.

2. The improved animal collar according to claim 1 wherein said first and second material are sewn together.

3. The improved animal collar according to claim 2 wherein said metallic insert comprises a lightweight aluminum alloy.

4. The improved animal collar according to claim 2 further comprising a protective insert nested between said first material and said metallic insert.

5. The improved animal collar according to claim 4 wherein said protective insert is an extension of said first material.

6. The improved animal collar according to claim 5 wherein said metallic insert comprises aluminum.

7. The improved animal collar according to claim 1 further comprising a protective insert nested between said first material and said metallic insert.

8. The improved animal collar according to claim 7 wherein said protective insert is an extension of said first material.

9. The improved animal collar according to claim 8 wherein said metallic insert comprises aluminum.

10. The improved dog collar according to claim 9 wherein said animal collar is a dog collar.

11. An improved dog collar for protecting the neck of a dog the improved dog collar comprising:
a. a first material and a second material sewn together;
b. a space within said first and second material;
c. a flat, curved noncorrosive metallic insert substantially encased within said space, the curved metallic insert comprising two curved ends and having no sharp edges; and
d. a latching mechanism for securing said improved dog collar about said neck of a dog.

12. The improved dog collar according to claim 12 further comprising a protective insert nested between said first material and said metallic insert.

13. The improved dog collar according to claim 13 wherein said protective insert is an extension of said first material.

14. The improved dog collar according to claim 11 wherein said metallic insert comprises a lightweight aluminum alloy.

15. The improved dog collar according to claim 14 further comprising a protective insert nested between said first material and said metallic insert.

16. The improved dog collar according to claim 15 wherein said protective insert is an extension of said first material.
